(19) United States
(12) Patent Application Publication
(10) Pub. No.: US 2024/0290337 A1
(43) Pub. Date: Aug. 29, 2024

(54) AUDIO PROCESSING DEVICE AND METHOD FOR SUPPRESSING NOISE

(71) Applicant: IRIS AUDIO TECHNOLOGIES LIMITED, London (GB)

(72) Inventors: Robert James RENG, Dinton (GB); Patrick NICHOLLS, Altrincham (GB); Matteo LIONELLO, Venezia (IT)

(21) Appl. No.: 18/654,728

(22) Filed: May 3, 2024

Related U.S. Application Data
(63) Continuation of application No. PCT/IB2022/060558, filed on Nov. 2, 2022.

(30) Foreign Application Priority Data
Nov. 5, 2021 (GB) 2115938.9

(51) Int. Cl. G10L 21/0208; G10L 25/18

(52) U.S. Cl. CPC G10L 21/0208; G10L 25/18

(57) ABSTRACT

An audio processing device for suppressing noise in an audio signal includes a receiving unit to receive an input audio signal, a transform unit to generate an input spectrogram based on the input audio, a noise suppression network to process the input spectrogram and an inverse transform unit to generate an output audio signal based on an output spectrogram from the noise suppression network. The noise suppression network includes an encoder module including a plurality of complex convolutional layers, a gated recurrent unit, GRU, network including a plurality of GRU cells, and a decoder module including a plurality of complex deconvolutional layers.

### CROSS-REFERENCE TO RELATED APPLICATIONS

This application is a continuation under 35 U.S.C. § 120 of International Application No. PCT/IB2022/060558, filed Nov. 2, 2022 which claims priority to GB Application No. 2115938.9, filed Nov. 5, 2021, under 35 U.S.C. § 119(a). Each of the above-referenced patent applications is incorporated by reference in its entirety.

### TECHNICAL FIELD

This invention relates in general to the field of audio processing and, in particular, to the suppression of noise in an audio signal.

### BACKGROUND

Noise suppression and voice isolation, in particular during voice communications is increasingly important.

Noise can be a distraction in any remote working environment, e.g. on VOIP and video calls, radio communications in sport, emergency services, air traffic control, call centres and so on. Example can include background hum from taking calls in a car, radio static on 2-way communications, background noise in critical broadcasts such as emergency services and air traffic control, babble in call centres and cafes. All of these situations bring with them troublesome sounds which can make communication more challenging.

In surveys, a majority of employees admit that their concentration and efficiency at work suffers from audio setbacks and research has shown that, on average, end-users are losing 29 minutes per week due to poor sound quality on voice calls. Poor audio quality on calls can mean dissatisfied clients and dissatisfied employees, resulting in frustration, irritation and annoyance.

Early efforts to remove noise have been based on signal processing using algorithmic spectral subtraction. These would plot the spectral signature of a certain noise, and if that spectral signature were present, those frequencies in the spectral signature would have their gain reduced. This is really only suitable for a particular type of sound, and these methods are only as good as the sound signature being used to determine what is noise. Each source of noise requires a radically different signature to identify it.

Another approach is referred to as Active Noise Cancellation (ANC), where microphones record the noise in the vicinity of the listener and invert the phase of that noise. The inverted phase stream is injected into the acoustic chamber of headphones along with the audio material that is being consumed. This has the effect of blocking the noise around the listener, however, this does nothing to remove noise on the audio signal itself. For example, on a call with two or more parties, an ANC device can suppress noise for only one party at most.

Existing solutions using conventional time-frequency domain methods to predict masks with neural networks are generally not lightweight enough to run on low grade CPUs, e.g. on laptops or mobile phones, without needing powerful GPU processing power. A solution would need to run on a range of different device types, from laptops to mobile phones, from high powered servers to low powered microchips running inside headphones. This presents significant difficulties because latency delays of audio processing would not be tolerable, and so it would be necessary to carry out spectral processing in a matter of milliseconds to prevent any noticeable delay on the communication stream wherever it was deployed.

The present invention aims to address these problems in the state of the art.

### SUMMARY

According to a first aspect of the present invention, there is provided an audio processing device according to claim 1.

According to a second aspect of the present invention, there is provided a method of training noise suppression network according to claim 8.

According to a third aspect of the present invention, there is provided a method of suppressing noise in an audio signal according to claim 12.

According to a fourth aspect of the present invention, there is provided a computer readable medium according to claim 19.

Optional features are as set out in the dependent claims.

### BRIEF DESCRIPTION OF THE DRAWINGS

For a better understanding of the present invention and to show more clearly how it may be carried into effect, reference will now be made by way of example only, to the accompanying drawings, in which:

FIG. 1 is a schematic diagram showing an audio processing device according to an embodiment;

FIG. 2 is an illustration showing a gated recurrent unit architecture, according to an embodiment;

FIG. 3 is a flowchart showing a method of training a noise suppression network according to an embodiment; and

FIG. 4 is a flowchart showing a method of suppressing noise in an audio signal according to an embodiment.

### DETAILED DESCRIPTION

The present invention relates to an audio processing device and a processing method for suppressing noise in an audio signal. In particular, an audio signal is processed using a phase aware noise suppression network which includes a gated recurrent unit (GRU) network.

FIG. 1 of the accompanying drawings shows an audio processing device 100 according to claim 1. The audio processing device 100 is configured to suppress noise in an audio signal. The audio processing device 100 comprises a receiving unit 110, a transform unit 120, a noise suppression network 130 and an inverse transform unit 140.

The audio processing device 100 is capable of suppressing or removing unwanted noise in an input audio signal 10. As the audio signal is processed directly, there is no need to an external microphone to record a source of noise or surrounding environment. As such, the device is capable of suppressing noise generated in the vicinity of the device or noise present in an audio signal received from elsewhere. In this way, for example, noise on both sides of an audio conversation between two user devices can be suppressed by a single audio processing device 100 at either end or between the two user devices.

The receiving unit 110 is configured to receive an input audio signal 10. For example, the receiving unit 110 may receive a voice signal (e.g. as part of an audio conversation) or a music signal or any other audio signal. The input audio signal 10 may include a primary component, e.g. a voice component or a music component, and an unwanted component or “noise” component. For example, the input audio signal 10 may include any background noise, static or compression/transmission artefacts which obscures, interferes with or distracts from the primary component.

In some examples, the input audio signal 10 may be generated by the audio processing device 100 e.g. using an input microphone. In some examples, the input audio signal 10 may be received from another device through any suitable wired or wireless connection. The input audio signal 10 may be received in any suitable digital or analog format. In some examples, the receiving unit 110 may include one or more pre-processing modules to convert or adjust the input audio signal 10 for processing e.g. a bandpass or low pass filter, analog-to-digital converter etc.

The transform unit 120 is configured to generate an input spectrogram based on the input audio signal 10. The transform unit 120 is configured to transform the input audio signal 10 from the time domain, i.e. time series waveform data, into the frequency domain. The input spectrogram can represent a magnitude of a plurality of frequency components in the input audio signal 10.

In some embodiments, the transform unit 120 is configured to use a short time fourier transform, SFTF, to transform a window of the input audio signal 10. The STFT may be configured to separate the input audio signal 10 into a sequence of windows, and perform a Fourier transform operation on each window. For example, the STFT may use a predetermined window size based on a predetermined number of samples or length of time e.g. a window size of 512 samples would be equivalent to roughly 30 milliseconds at 16 khz. In this way, the STFT may generate an input spectrogram corresponding to each window of the audio signal. The STFT may generate a time-series of input spectrograms.

In some embodiments, the transform unit 120 includes a buffer and is configured to overlap adjacent windows according to the buffer size. In this way, information about adjacent windows can be accumulated. This can prevent spectral leakage, where each window leaks some information about the next window, along with distortion caused by phase alignment problems.

To operate in real time, the buffers should be short enough to process quickly, but long enough for the noise suppression network 130 to receive enough information. An optimum buffer length can therefore be determined, where a longer buffer sizes provides the best quality output, and a shorter buffer size provides faster processing.

The noise suppression network 130 is configured to process the input spectrogram. The noise suppression network 130 comprises an encoder module 131, a gated recurrent unit (GRU) network 132 and a decoder module 133. The encoder module 131 includes a plurality of complex convolutional layers and the decoder module 133 includes a plurality of complex deconvolutional layers.

By implementing an encoder and decoder module which respectively include complex convolutional and deconvolutional layers, the noise suppression network 130 is capable of processing both real and imaginary values of the input audio signal 10, that is, the noise suppression network 130 is considered to be “phase-aware”. In this way, the device can provide a more efficient means of audio noise suppression which can be implemented in real time, with lower requirements for power consumption and processing power. For example, the device can be implemented in devices with lower processing power e.g. laptop computers, mobile phone devices or within headphones.

The encoder module 131 is configured to shrink and compress data in the input spectrogram. The encoder module 131 includes a plurality of complex convolutional layers. The complex convolutional layers of the encoder module 131 may be configured to operate on complex values of the input spectrogram. Each layer may have a varying number of channels corresponding to a number of filter weights inside that particular layer. In some examples, each subsequent layer may have fewer channels than the preceding layer. In some examples, the encoder module 131 may include six complex convolutional layers.

The GRU, network includes a plurality of GRU cells. The plurality of GRU cells may be arranged in a series where each GRU cell is connected to at least one preceding or following GRU cell. Each GRU cell may be configured to receive an input, xₜ, corresponding to a time t. Each GRU cell may be configured to generate a hidden state cₜ, corresponding to the time t. Each GRU cell after the first may be configured to receive a hidden state, cₜ₋₁, from a preceding GRU corresponding to a preceding time point t−1.

In some embodiments, each GRU cell is configured to preserve a long-term memory of a respective cell state. In this way, by preserving a long-term memory, the GRU network 132 can provide improved performance of time-series and sequential tasks such as audio processing. This can allow the audio processing device 100 to process the audio signal more efficiently, with lower requirements for power consumption and processing power.

In some embodiments, each GRU cell includes an update gate configured to update the cell state with a new candidate state, and a reset gate configured to keep or discard the previous cell state.

In this way, the update gate can help the noise suppression network 130 to determine how much of the past information (from previous time steps) needs to be passed along to the future, and the reset gate can be used to decide how much of the past information to forget. In this way, the GRU network 132 can account for both long term and short term dependencies in the audio signal.

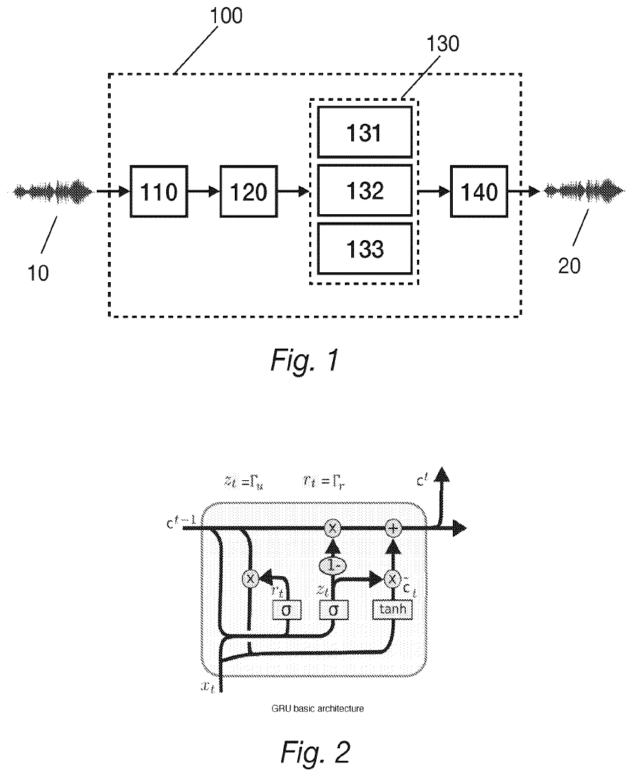

FIG. 2 of the accompanying drawings shows an architecture for a GRU cell, according to an embodiment.

The GRU cell generates an update gate, zₜ=Γᵤ, and a reset gate, rₜ=Γᵣ. The reset gate is configured to control how much of the previous state is remembered. The update gate is configured to control how much of the new state is a copy of the old state.

As such, the reset and update gates receive the input of the current time step, xₜ, and the hidden state of the previous time step, cₜ₋₁. The outputs of two gates may be given by two fully connected layers with a sigmoid activation function. Mathematically, the gates may be given by:

rₜ=σ(xₜWₓᵣ+cₜ₋₁Wₕᵣ+bᵣ)

zₜ=σ(xₜW_{xz}+cₜ₋₁W_{hz}+bᵣ)

Where W indicates a weight parameter and b indicates a bias. Sigmoid functions may be used to transform the input values to an interval (0,1).

The GRU cell generates a candidate hidden state čₜ at time step t. Mathematically, the candidate hidden state may be given by:

čₜ=tanh(xₜW_{xc}+(rₜ⊙cₜ₋₁)W_{cc}+b_{c})

Where W indicates a weight parameter and b indicates a bias. The symbol ⊙ may indicate a product operator e.g. a Hadamard (elementwise) product operator. A hyperbolic tangent function may be used to ensure that the values in the candidate hidden state remain in an interval (−1,1).

The GRU cell generates a final update value or hidden state Ct at time step t, based on the update gate. The update gate may be configured to determine the extent to which the hidden state cₜ is based on each of the preceding hidden state cₜ₋₁ and the candidate hidden state čt. Mathematically the hidden state may be given by:

cₜ=(1−zₜ)⊙cₜ₋₁+zₜ+zₜ⊙čₜ

In some embodiments, inputs and outputs of each GRU cell are complex values. The complex input values may be provided by the complex convolutional layers of the encoder module 131. The complex output values may be processed by the complex deconvolutional layers of the decoder module 133.

In this way, the full noise suppression network 130 is capable of processing both real and imaginary values of the input audio signal 10 in a phase-aware end-to-end process.

The decoder module 133 is configured to expand and decompress data as it is output from the GRU network 132. The decoder module 133 includes a plurality of complex deconvolutional layers. The complex convolutional layers of the decoder module 133 are configured to operate on complex values of the received data. Each layer may have a varying number of channels corresponding to a number of filter weights inside that particular layer. In some examples, each subsequent layer may have more channels than the preceding layer. In some examples, the decoder module 133 may include six complex convolutional layers.

In some embodiments, the noise suppression network 130 may include a dense, or “fully connected”, layer which connects every input to an output. The dense layer may be arranged between the GRU network 132 and the decoder module 133. The dense layer may be configured to stabilize an output of the GRU network 132 for input into the decoder module 133.

The inverse transform unit 140 is configured to generate an output audio signal 20 based on an output spectrogram from the noise suppression network 130. The inverse transform unit 140 is configured to transform the processed spectrogram back into time series waveform data. In some embodiments, the inverse transform unit 140 is configured to use an inverse short time fourier transform, ISTFT. The output audio signal 20 may correspond to the input audio signal 10, with a lower level of unwanted noise. For example, the output audio signal 20 may include a voice component of the input audio signal 10, e.g. part of an audio conversation, with one or more components of noise suppressed or removed.

The audio processing device 100 may further include an immersive audio processing unit (not shown). The immersive audio processing unit may include a polyphase infinite impulse response, IIR, filter. The IIR filter may be configured to process the output audio signal 20 and generate an immersive audio signal.

When combined with the noise suppression network 130, the immersive audio processing unit can provide a dual benefit of both noise suppression and a more natural sounding audio signal. By applying the IIR filter to the output audio signal 20 which has already been processed by the noise suppression network 130, an improved immersive audio signal can be generated e.g. in comparison with performing immersive audio processing followed by the noise suppression network 130.

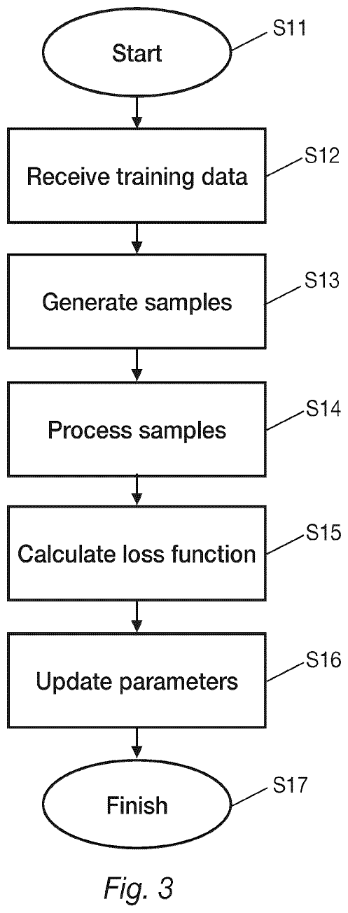

FIG. 3 of the accompanying drawings shows a flowchart representing a method of training a noise suppression network according to an embodiment. The method starts at step S11.

At step S12, the method includes receiving training data including a plurality of clean audio samples and a plurality of environmental noise samples. In some examples, the training data may be obtained directly, e.g. by recording, or may be received from one or more data sources, e.g. public or private sound libraries.

A clean audio sample may include a primary component e.g. a voice component or a music component, with substantially no noise component. For example, a clean audio sample including a voice component may have been recorded in a special environment (e.g. a studio or an anechoic chamber) to reduce the presence of background noise. Alternatively, or in addition, the clean audio signal may have been extensively processed to remove noise. In some examples, the plurality of clean audio samples may relate to a variety of audio classifications, e.g. clean audio samples for voice may be classified by male/female speech, different languages, different emotions/excitement levels etc. Similarly, clean audio samples for music may be classified by genre, tempo, vocals/instrumental etc. In some embodiments, each clean audio sample may be tagged according to the classification.

An environmental noise sample may include an example of any type of noise expected in real world use. For example, the plurality of environmental noise samples may include samples of car noise, machinery, background conversation, alarms, electronic hum, static, kitchen noise, animal/baby noises etc. In some embodiments, each environmental noise sample may be tagged according to the type of noise.

At step S13, the method includes generating training samples by merging at least one clean audio sample and at least one environmental noise sample. In some embodiments, the training samples are generated to provide a predetermined range of signal-to-noise ratio values. In some examples, the clean audio sample and environmental noise sample may be selected at random from a pool of samples which meet a desired criterion e.g. based on audio classification or noise type. In some examples, a training sample may be generated by selecting one or more fixed length portions from each of the clean audio sample and environmental noise sample. For example, a portion of e.g. 1 second may be extracted from a randomly selected position within each sample.

At step S14, the method includes processing the training samples using the noise suppression network 130.

In some embodiments, the training samples are batched according to an audio classification of the corresponding clean audio sample, a noise type of the corresponding environmental noise sample, and a signal-to-noise ratio. In some examples, a full training epoch including all of the training samples may be separated into approximately 50,000 batches. Each batch may include approximately 50-100 samples. In this way, by focusing on separate batches having common characteristics, the training method can provide an improved performance of the noise suppression network 130.

In some embodiments, the batches are grouped into mini-epochs according to audio quality and noise type. In some examples, the full training epoch may be divided into approximately 10 mini-epochs. In some embodiments, each mini-epoch includes a range of signal-to-noise ratio values ordered from low to high. By proceeding from low to high signal-to-noise ratio values in this way, the training method can provide an improved performance of the noise suppression network 130.

At step S15, the method includes calculating a value for a permutation invariant loss function based on the output audio signal 20 of the audio processing device 100 and the clean audio sample corresponding to each training sample. By using a permutation invariant loss function, the training method can account for variations in the plurality of clean audio samples and environmental noise samples.

At step S12, the method includes updating one or more parameters of the noise suppression network 130 to reduce the value of the permutation invariant loss function.

In some embodiments, the method may continue updating the parameters of the noise suppression network 130 until the permutation invariant loss function reaches a local minimum value or, alternatively, until the full training epoch is completed.

The method finishes at step S17.

In some embodiments, the audio processing device 100 described above may be trained according to this method. By using a machine learning approach rather than filter design, the method can provide a trained audio processing device 100 which is capable of more accurately predicting what is noise and what is the primary component in a noisy input audio signal.

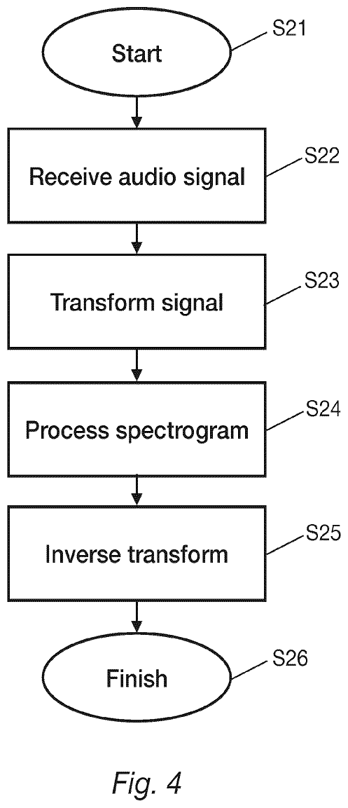

FIG. 4 of the accompanying drawings shows a flowchart representing a method of suppressing noise in an audio signal according to an embodiment. The method is capable of suppressing or removing unwanted noise in an input audio signal. As the audio signal is processed directly, there is no need to an external microphone to record a source of noise or surrounding environment. As such, the method is capable of suppressing noise generated in the vicinity of the device or noise present in an audio signal received from elsewhere. In this way, for example, noise on both sides of an audio conversation between two user devices can be suppressed by a single audio processing device at either end or between the two user devices.

The method starts at step S21.

At step S22, the method includes receiving an input audio signal.

For example, the input audio signal may include a voice signal (e.g. as part of an audio conversation) or a music signal or any other audio signal. The input audio signal may include a primary component, e.g. a voice component, and an unwanted component or “noise” component. For example, the input audio signal may include any background noise, static or compression/transmission artefacts which obscures, interferes with or distracts from the primary component.

In some examples, the input audio signal may be generated by an audio processing device implementing the method e.g. using an input microphone. In some examples, the input audio signal may be received from another device through any suitable wired or wireless connection. The input audio signal may be received in any suitable digital or analog format. In some examples, the receiving step may include one or more pre-processing steps to convert or adjust the input audio signal for processing e.g. using a bandpass or low pass filter, analog-to-digital converter etc.

At step S23, the method includes transforming the input audio signal to generate an input spectrogram. The input audio signal is transformed from the time domain, i.e. time series waveform data, into the frequency domain. The input spectrogram can represent a magnitude of a plurality of frequency components in the input audio signal. In some embodiments, the transforming step uses a short time fourier transform, SFTF, to transform a window of the input audio signal.

The STFT may be configured to separate the input audio signal into a sequence of windows, and perform a Fourier transform operation on each window. For example, the STFT may use a predetermined window size based on a predetermined number of samples or length of time e.g. a window size of 512 samples would be equivalent to roughly 30 milliseconds at 16 khz. In this way, the STFT may generate an input spectrogram corresponding to each window of the audio signal. The STFT may generate a time-series of input spectrograms.

In some embodiments, the transforming step includes overlapping adjacent windows according to a size of a buffer. In this way, information about adjacent windows can be accumulated. This can prevent spectral leakage, where each window leaks some information about the next window, along with distortion caused by phase alignment problems.

To operate in realtime, the buffer should be short enough to process quickly, but long enough for the noise suppression network to receive enough information. An optimum buffer length can therefore be determined, where a longer buffer sizes provides the best quality output, and a shorter buffer size provides faster processing.

At step S24, the method includes processing the input spectrogram using a noise suppression network. The noise suppression network comprises an encoder module, a gated recurrent unit (GRU) network and a decoder module. The encoder module includes a plurality of complex convolutional layers and the decoder module includes a plurality of complex deconvolutional layers.

By implementing an encoder and decoder module which respectively include complex convolutional and deconvolutional layers, the noise suppression network is capable of processing both real and imaginary values of the input audio signal, that is, the noise suppression network is considered to be “phase-aware”. In this way, the device can provide a more efficient means of audio noise suppression which can be implemented in real time, with lower requirements for power consumption and processing power. For example, the device can be implemented in devices with lower processing power e.g. laptop computers, mobile phone devices or within headphones.

The encoder module is configured to shrink and compress data in the input spectrogram. The encoder module includes a plurality of complex convolutional layers. The complex convolutional layers of the encoder module may be configured to operate on complex values of the input spectrogram. Each layer may have a varying number of channels corresponding to a number of filter weights inside that particular layer. In some examples, each subsequent layer may have fewer channels than the preceding layer. In some examples, the encoder module may include six complex convolutional layers.

The GRU, network includes a plurality of GRU cells. The plurality of GRU cells may be arranged in a series where each GRU cell is connected to at least one preceding or following GRU cell. Each GRU cell may be configured to receive an input, xt, corresponding to a time t. Each GRU cell may be configured to generate a hidden state ct, corresponding to the time t. Each GRU cell after the first may be configured to receive a hidden state, ct−1, from a preceding GRU corresponding to a preceding time point t−1.

In some embodiments, each GRU cell is configured to preserve a long-term memory of a respective cell state. In this way, by preserving a long-term memory, the GRU network can provide improved performance of time-series and sequential tasks such as audio processing. This can allow the audio processing device to process the audio signal more efficiently, with lower requirements for power consumption and processing power.

In some embodiments, each GRU cell includes an update gate configured to update the cell state with a new candidate state, and a reset gate configured to keep or discard the previous cell state. In this way, the update gate can help the noise suppression network to determine how much of the past information (from previous time steps) needs to be passed along to the future, and the reset gate can be used to decide how much of the past information to forget. In this way, the GRU network can account for both long term and short term dependencies in the audio signal.

In some embodiments, inputs and outputs of each GRU cell are complex values. The complex input values may be provided by the complex convolutional layers of the encoder module. The complex output values may be processed by the complex deconvolutional layers of the decoder module.

In this way, the full noise suppression network is capable of processing both real and imaginary values of the input audio signal in a phase-aware end-to-end process.

The decoder module is configured to expand and decompress data as it is output from the GRU network. The decoder module includes a plurality of complex deconvolutional layers. The complex convolutional layers of the decoder module are configured to operate on complex values of the received data. Each layer may have a varying number of channels corresponding to a number of filter weights inside that particular layer. In some examples, each subsequent layer may have more channels than the preceding layer. In some examples, the decoder module may include six complex convolutional layers.

In some embodiments, the noise suppression network may include a dense, or “fully connected”, layer which connects every input to an output. The dense layer may be arranged between the GRU network and the decoder module. The dense layer may be configured to stabilize an output of the GRU network for input into the decoder module.

At step S25, the method includes inverse transforming an output spectrogram from the noise suppression network to generate an output audio signal. The inverse transforming step includes transforming the processed spectrogram back into time series waveform data. In some embodiments, the inverse transforming step uses an inverse short time fourier transform, ISTFT. The output audio signal may correspond to the input audio signal, with a lower level of unwanted noise. For example, the output audio signal may include a voice component of the input audio signal, e.g. part of an audio conversation, with one or more components of noise suppressed or removed.

The method finishes at step S26.

In some embodiments, the method may further include processing the output audio signal and generating an immersive audio signal using an immersive audio processing unit comprising a polyphase infinite impulse response, IIR, filter.

When combined with the noise suppression network, the immersive audio processing unit can provide a dual benefit of both noise suppression and a more natural sounding audio signal. By applying the IIR filter to the output audio signal which has already been processed by the noise suppression network, an improved immersive audio signal can be generated e.g. in comparison with performing immersive audio processing followed by the noise suppression network.

In some implementations the method may be implemented in a computer readable medium comprising instructions which, when executed by a processor, cause the processor to perform the method.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the scope of the invention as defined by the appended claims.

1. An audio processing device for suppressing noise in an audio signal, comprising:
a receiving unit configured to receive an input audio signal;
a transform unit configured to generate an input spectrogram based on the input audio signal;
a noise suppression network configured to process the input spectrogram, comprising:
an encoder module including a plurality of complex convolutional layers;
a gated recurrent unit, GRU, network including a plurality of GRU cells; and
a decoder module including a plurality of complex deconvolutional layers; and
an inverse transform unit configured to generate an output audio signal based on an output spectrogram from the noise suppression network.

2. The audio processing device of claim 1, wherein each GRU cell is configured to preserve a long-term memory of a respective cell state.

3. The audio processing device of claim 2, wherein each GRU cell includes an update gate configured to update the cell state with a new candidate stale, and a reset gate configured to keep or discard the previous cell state.

4. The audio processing device of claim 1, wherein inputs and outputs of each GRU cell are complex values.

5. The audio processing device of claim 1, wherein the transform unit is configured to use a short time Fourier transform, SFTF, to transform a window of the input audio signal, and the inverse transform unit is configured to use an inverse short time Fourier transform, ISTFT.

6. The audio processing device of claim 5, wherein the transform unit includes a buffer and is configured to overlap adjacent windows according to the buffer size.

7. The audio processing device of claim 1, further comprising an immersive audio processing unit comprising a polyphase infinite impulse response, IIR, filter configured to process the output audio signal and generate an immersive audio signal.

8. A method of training a noise suppression network of an audio processing device, comprising:
receiving training data including a plurality of clean audio samples and a plurality of environmental noise samples;
generating training samples by merging at least one clean audio sample and at least one environmental noise sample;
processing the training samples using the noise suppression network;
calculating a value for a permutation invariant loss function based on an output audio signal of the audio processing device and the clean audio sample corresponding to each training sample; and
updating one or more parameters of the noise suppression network to reduce the value of the permutation invariant loss function.

9. The method of claim 8, wherein the training samples are generated to provide a predetermined range of signal-to-noise ratio values.

10. The method of claim 8, wherein the training samples are batched according to an audio classification of the corresponding clean audio sample, a noise type of the corresponding environmental noise sample, and a signal-to-noise ratio.

11. The method of claim 10, wherein the batches are grouped into mini-epochs according to audio quality and noise type, wherein each mini-epoch includes a range of signal-to-noise ratio values ordered from low to high.

12. A method of suppressing noise in an audio signal, comprising:
receiving an input audio signal;
transforming the input audio signal to generate an input spectrogram;
processing the input spectrogram using a noise suppression network comprising:
an encoder module including a plurality of complex convolutional layers;
a gated recurrent unit, GRU, network including a plurality of GRU cells; and
a decoder module including a plurality of complex deconvolutional layers; and
inverse transforming an output spectrogram from the noise suppression network to generate an output audio signal.

13. The method of claim 12, wherein each GRU cell is configured to preserve a long-term memory of a respective cell state.

14. The method of claim 13, wherein each GRU cell includes an update gate configured to update the cell state with a new candidate state, and a reset gate configured to keep or discard the previous cell state.

15. The method of claim 12, wherein inputs and outputs of each GRU are complex values.

16. The method of claim 12, wherein transforming includes using a short time Fourier transform, SFTF, to transform a window of the input audio signal, and inverse transforming includes using an inverse short-term Fourier transform, ISTFT.

17. The method of claim 16, wherein transforming includes overlapping adjacent windows according to a buffer size.

18. The method of claim 12, further comprising processing the output audio signal and generating an immersive audio signal using an immersive audio processing unit comprising a polyphase infinite impulse response, IIR, filter.

19. The audio processing device of claim 1, wherein the noise suppression network has been trained using operations comprising:
receiving training data including a plurality of clean audio samples and a plurality of environmental noise samples;
generating training samples by merging at least one clean audio sample and at least one environmental noise sample;
processing the training samples using the noise suppression network;
calculating a value for a permutation invariant loss function based on the output audio signal of the audio processing device and the clean audio sample corresponding to each training sample; and
updating one or more parameters of the noise suppression network to reduce the value of the permutation invariant loss function.

20. A non-transitory computer readable medium comprising instructions which, when executed by a processor, cause the processor to carry out operations comprising:
receiving an input audio signal;
transforming the input audio signal to generate an input spectrogram;
processing the input spectrogram using a noise suppression network comprising:
an encoder module including a plurality of complex convolutional layers;
a gated recurrent unit, GRU, network including a plurality of GRU cells; and
a decoder module including a plurality of complex deconvolutional layers; and
inverse transforming an output spectrogram from the noise suppression network to generate an output audio signal.
